(19) United States
(12) Patent Application Publication
(10) Pub. No.: US 2007/0088546 A1
(43) Pub. Date: Apr. 19, 2007

(54) Apparatus and method for transmitting audio signals

(76) Inventors: Geun-Bae Song, Jecheon-si (KR); Jae-Bum Kim, Seoul (KR); Chul-Yong Ahn, Suwon-si (KR); Ho-Chong Park, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/519,219

(22) Filed: Sep. 12, 2006

(30) Foreign Application Priority Data
Sep. 12, 2005 (KR) 2005-84780

(51) Int. Cl. G10L 15/20

(52) U.S. Cl. 704/233

(57) ABSTRACT

An apparatus and a method for transmitting audio signals in such a manner that audio signals transmitted and received in a mobile telephone network are preprocessed before being inputted to a voice encoder are provided. The audio signals are preprocessed by using an optimal filter gain based on error signals obtained when the audio signals are preprocessed and outputted by the voice encoder and the synthesizer. Therefore, the sound quality of the audio signals is hardly degraded by the voice encoder.

### CROSS-REFERENCE TO RELATE APPLICATION

This application claims the benefit under 35 U.S.C. § 119(a) of a Korean Patent Application filed with the Korean Intellectual Property Office on Sep. 12, 2005 and assigned Serial No. 2005-84780, the entire disclosure of which is hereby incorporated by reference.

### BACKGROUND OF THE INVENTION

1. Field of the Invention:

The present invention relates to an apparatus and a method for transmitting audio signals. More particularly, the present invention relates to an apparatus and a method for transmitting audio signals in such a manner that the audio signals transmitted and received in a mobile telephone network are preprocessed before being inputted to a voice encoder.

2. Description of the Related Art:

Variable-rate voice encoders used in mobile telephone networks support a creation of voice packets having a plurality of rates. Typical examples of the variable-rate voice encoders include Qualcomm-CELP (QCELP) and Enhanced Variable Rate Codec (EVRC) used in Code Division Multiple Access (CDMA) systems. The variable-rate voice encoders can select the rate of voice packets according to characteristics of inputted voice signals or based on the rate required by communication systems to compress or restore voice signals. The QCELP and EVRC create voice packets having a full rate, ½ rate, ¼ rate, or ⅛ rate. These encoders are based on a human voice creation model and exhibit optimal performance in compressing and decoding voice signals. However, the encoders exhibit poor performance with regard to signals (for example, music) having a creation model different from the voice creation model. This means that, when audio signals are transmitted and received in conventional mobile telephone networks, some measures must be taken to lessen the degradation of sound quality.

FIG. 1 shows a conventional method for lessening the degradation of sound quality of audio signals, by using a music detector 112, in a mobile communication network using a voice encoder. As shown in FIG. 1, the music detector 112 is positioned in front of a voice encoder 114 and determines if an input signal s[n] is an audio signal. If the music detector 112 determines that the input signal s[n] is an audio signal, the voice encoder 114 compresses the input signal s[n] to the maximum rate and transmits it. If the input signal s[n] is not an audio signal but a voice signal, it is compressed to a rate suitable for the characteristics of voice signals and transmitted.

FIG. 2 shows another conventional method for lessening the degradation of sound quality of audio signals in a mobile communication network using a voice encoder. A preprocessor 220 is positioned in front of a voice encoder 216 so that audio signals to be transmitted via a mobile telephone network are subjected to preprocessing, that is dynamic range compression 212 and pitch enhancement 214. When the preprocessed audio signals are processed by the voice encoder 216 during transmission, the probability that rate will be reduced to 1/8 is reduced substantially. This means that interruption of sound decreases. The method shown in FIG. 2 aims at influencing the rate determined by the voice encoder 216 by modifying (that is, preprocessing) original audio signals to such an extent that the modification is not noticed by humans.

The methods shown in FIGS. 1 and 2 are intended to increase the rate of a voice encoder so that when the voice encoder is made to process inputted audio signals at the maximum rate, unexpected interruption of sound is prevented. However, the conventional methods have a fundamental limitation in that, since voice encoders currently used in mobile telephone networks are optimized for human voices, they output heavily distorted sounds even when audio signals are processed at the maximum rate.

Accordingly, there is a need for an improved apparatus and method for compensating for a degree of sound quality resulting from characteristics of voice encoders, in order to improve the sound quality of audio signals transmitted and received in mobile telephone networks.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an apparatus and a method for preprocessing audio signals in an analysis-by-synthesis scheme and transmitting the audio signals.

Another aspect of exemplary embodiments of the present invention is to provide an apparatus and a method for optimally preprocessing audio signals and transmitting the audio signals by using error signals between original audio signals and signals obtained by preprocessing the original signals with a frequency filter, encoding the audio signals with a voice encoder, and decoding the audio signals.

Another aspect of exemplary embodiments of the present invention is to provide an apparatus and a method for preprocessing audio signals by multiplying the frequency component of the audio signals by a specific filter gain value and transmitting the audio signals.

Another aspect of exemplary embodiments of the present invention is to provide an apparatus and a method for transmitting audio signals with lesser degradation of their sound quality resulting from a voice encoder in a mobile telephone network.

In order to accomplish an aspect of exemplary embodiments of the present invention, there is provided an apparatus for transmitting audio signals, in which a preprocessing filter converts an audio signal into a frequency domain and multiplying each frequency component by a filter gain value, the audio signal being inputted according to a frame, the preprocessing filter converts the audio signal in the frequency domain into a time domain and outputs the audio signal; a first voice encoder/synthesizer voice-encodes the audio signal outputted by the preprocessing filter, decodes the audio signal, and synthesizes the audio signal; a comparator outputs an error signal based on an error between the audio signal outputted by the first voice encoder/synthesizer and the audio signal inputted to the preprocessing filter; a second voice encoder voice-encodes the audio signal outputted by the preprocessing filter and transmitting the audio signal; and a filter gain/switch controller calculates a filter gain from the error signal outputted by the comparator and the audio signal inputted to the preprocessing filter, the filter gain being provided to the preprocessing filter, the filter gain/switch controller controls the preprocessing filter, when the filter gain is an optimal filter gain, so that the audio signal is processed according to the optimal filter gain and outputted to the second voice encoder.

In an exemplary implementation, the preprocessing filter includes a frequency converter for converting the audio signal into the frequency domain, the audio signal having been inputted to the preprocessing filter; a frequency filter for multiplying the audio signal by the filter gain value, the audio signal having been converted into the frequency domain by the frequency converter, and outputting the audio signal; and an inverse frequency converter for converting the audio signal into the time domain, the audio signal having been outputted by the frequency filter.

In an exemplary implementation, the filter gain/switch controller includes a frequency band-based Signal-to-Noise Ratio (SNR) calculator for converting the error signal outputted by the comparator and the audio signal inputted to the preprocessing filter into the frequency domain, respectively, and calculating an SNR for each frequency band; a frequency band-based filter gain calculator for calculating the filter gain for each frequency band by using the SNR calculated by the frequency band-based SNR calculator; a postprocessor for adjusting deviation of the filter gain and providing the filter gain to the preprocessing filter; and a switch controller for controlling the preprocessing filter, when the filter gain is an optimal filter gain, so that the audio signal is processed according to the optimal filter gain and outputted to the second voice encoder.

### BRIEF DESCRIPTION OF THE DRAWINGS

The above and other objects, features, and advantages of certain exemplary embodiments of the present invention will be more apparent from the following detailed description taken in conjunction with the accompanying drawings, in which:

FIGS. 1 and 2 show the construction of conventional apparatuses for transmitting audio signals, respectively;

FIG. 3 shows the construction of an apparatus for transmitting audio signals according to an exemplary embodiment of the present invention;

FIG. 4 shows the detailed construction of a preprocessing filter of the apparatus shown in FIG. 3;

FIGS. 5 and 6 show examples of frequency division according to an exemplary embodiment of the present invention, respectively;

FIG. 7 shows the detailed construction of a filter gain/switch controller of the apparatus shown in FIG. 3;

FIG. 8 shows an example of smoothing the filter gain according to an exemplary embodiment of the present invention; and

FIG. 9 is a flowchart showing a method for transmitting audio signals according to an exemplary embodiment of the present invention.

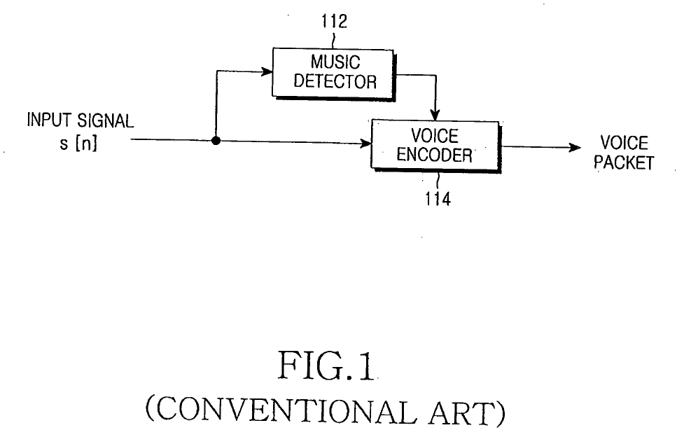

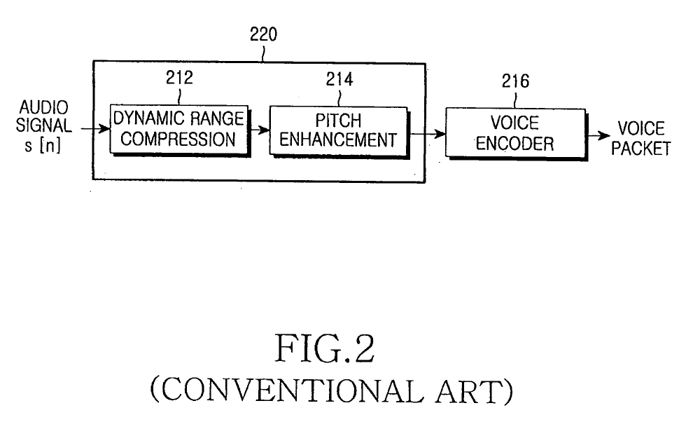

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

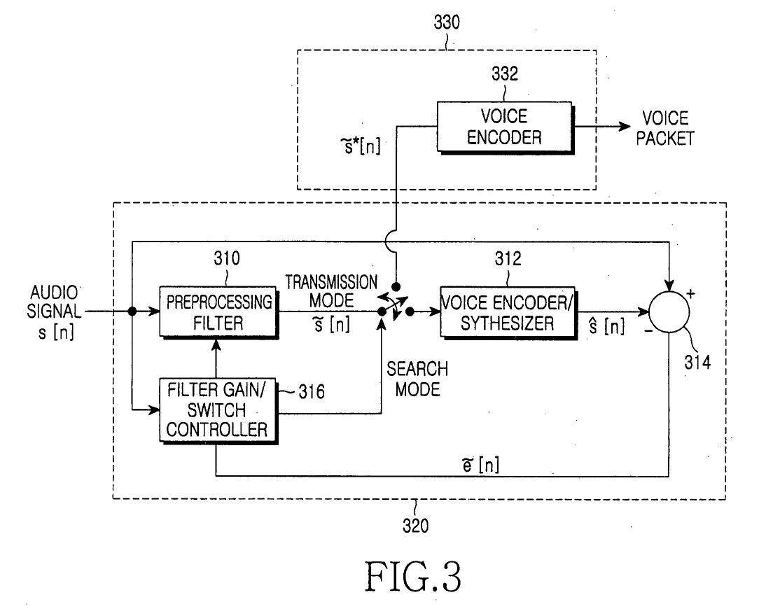

FIG. 3 shows the construction of an apparatus for transmitting audio signals according to an exemplary embodiment of the present invention. The apparatus includes a preprocessor 320 and a signal transmitter 330. The preprocessor 320 includes a preprocessing filter 310, a voice encoder/synthesizer 312, a comparator 314, and a filter gain/switch controller 316. The apparatus has a closed-loop structure so that an error signal \tilde{e}[n] outputted from the comparator 314 is fed back to the preprocessor 310. The signal transmitter 330 has a voice encoder 332.

The preprocessor 320 receives audio signals based on frames, preprocesses them into signals suitable for the voice encoder 332 by using the preprocessing filter 310, and outputs them to the signal transmitter 330. A number of feedback processes are conducted to create optimally preprocessed signals for each frame. A search process for creating optimally preprocessed signals is terminated when the feedback process is repeated a predetermined number of times or when a calculated error signal \tilde{e}[n] satisfies a predetermined criterion. Then, finally preprocessed signals are outputted for transmission. For example, the preprocessing process according to an exemplary embodiment of the present invention is divided into a search mode and a transmission mode. In the search mode, an optimal filter gain is searched for to be used by the preprocessing filter 310 for optimally preprocessed signals. In the transmission mode, the signal transmitter 330 uses the optimal filter gain to transmit the preprocessed signals to the voice encoder 332.

An input audio signal s[n] of a frame passes through the preprocessing filter 310 in the search mode. The input audio signal s[n] moves through the voice encoder/synthesizer 312 and reaches the comparator 314, which then creates an error signal \tilde{e}[n] from the input audio signal s[n]. Together with the input audio signal s[n], the error signal \tilde{e}[n] is used by the filter gain/switch controller 316 to obtain an optimal preprocessing filter gain for the current input frame. This process continues until feedback is repeated a predetermined number of times or a calculated error signal \tilde{e}[n] satisfies a predetermined criterion. Respective components of the preprocessor 320 will now be described in detail.

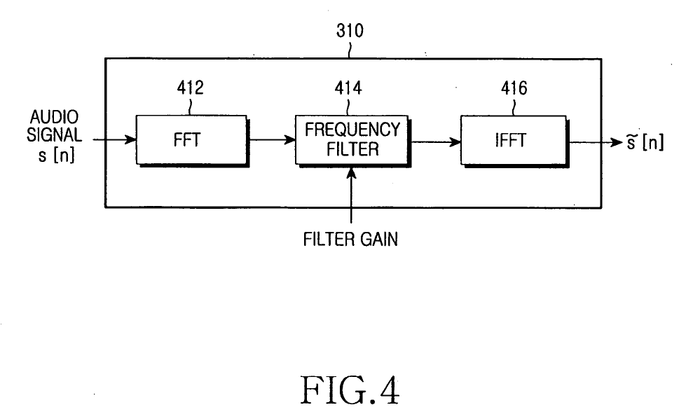

The preprocessing filter 310 is a frequency-domain filter. The preprocessing filter 310 converts an input audio signal s[n] in a time domain into a signal in a frequency domain and multiplies respective frequency components by a specific filter gain value. The resultant is converted into a signal in the time domain. As a result, a filtered signal is outputted. FIG. 4 shows the detailed construction of the preprocessing filter 310, which includes an FFT (Fast Fourier Transform) converter 412 , a frequency filter 414, and an IFFT (Inverse FFT) converter 416.

The FFT converter 412 FFT-converts a time-domain input audio signal s[n] into a frequency-domain signal. The frequency filter 414 has a filter gain and frequency response characteristics based on a filter gain value provided by the filter gain/switch controller 316. For example, the frequency filter 414 multiplies an audio signal, which has been FFT-converted into the frequency domain, by a filter gain and a filter gain value provided by the filter gain/switch controller 316. The IFFT converter 416 IFFT-converts the resultant and outputs a preprocessed time-domain audio signal \tilde{s}[n]. Before the feedback process, the filter gain is initialized to 1.

The voice encoder/synthesizer 312 is composed of an encoder, which has the same construction as the voice encoder 332 used for signal transmission, and a corresponding synthesizer. The voice encoder/synthesizer 312 is used to accurately model the encoding and decoding processes of signal transmission channels. The voice encoder/synthesizer 312 consists of a voice encoder having the same function as the voice encoder 332 of the signal transmitter 330 and a synthesizer having the same function as a decoder used in the reception side. For example, the voice encoder/synthesizer 312 may be made up of a linear prediction analyzer and a synthesizer, a pitch analyzer and a synthesizer, or a Fixed Code Book (FCB) analyzer and a synthesizer.

The comparator 314 calculates the difference (that is, encoding error signal) \tilde{e}[n] between the input audio signal s[n] and the audio signal \tilde{s}[n] outputted by the voice encoder/synthesizer 312. The error signal \tilde{e}[n] calculated by the comparator 314 is used as an input signal to the filter gain/switch controller 316 together with the input audio signal s[n].

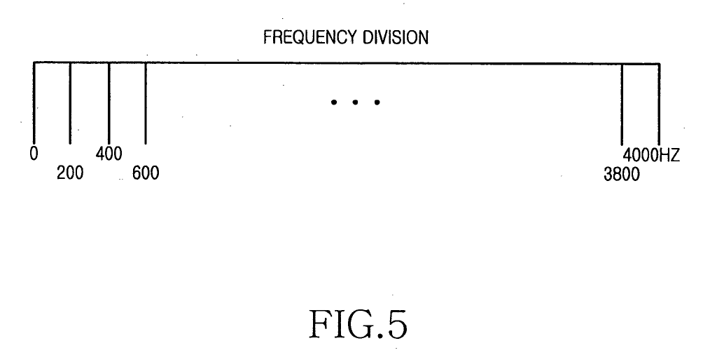

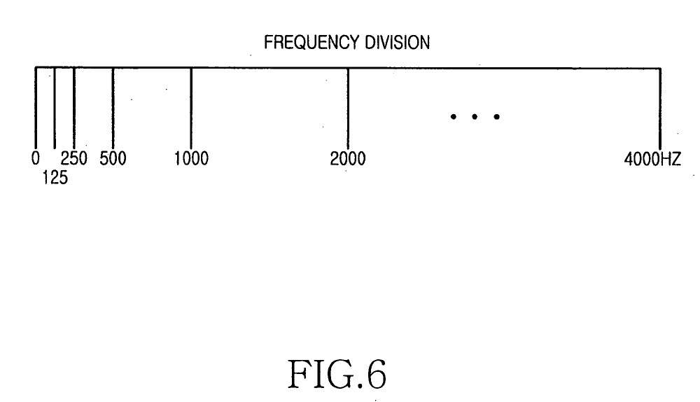

The filter gain/switch controller 316 obtains an optimal preprocessing filter gain for the current input frame with reference to the error signal \tilde{e}[n] and the input audio signal s[n]. As used herein, the filter gain refers to a frequency gain value used to determine the frequency response characteristics of the frequency filter 414. In an extreme case, the filter gain may be calculated for each frequency component of a single frame input audio signal. For example, if a frame of an input audio signal consists of 160 samples (20 ms), the number of frequency components to be filtered when the samples are to be filtered after 256 point FFT transform is 128. When different filter gains must be used for respective frequency components, a total of 128 gain values must be calculated for each frame. Such an approach of calculating and processing filter gain values for respective frequency components is inefficient when characteristics of human auditory recognition are taken into account. Human ability to discern frequencies is not uniform along the frequency axis, and there is a frequency masking effect. Considering this fact, respective components may be grouped in the frequency domain into a number of bands and the same gain may be used in the same band. This reduces the amount of calculation without affecting the performance. Selection of a method for grouping bands depends on the characteristics of input audio signals or target environments. FIG. 5 shows an example of dividing frequencies at the same interval, and FIG. 6 shows an example of dividing frequencies in a tree structure. Furthermore, a bark-scale-type frequency division method based on an auditory recognition model is another good example.

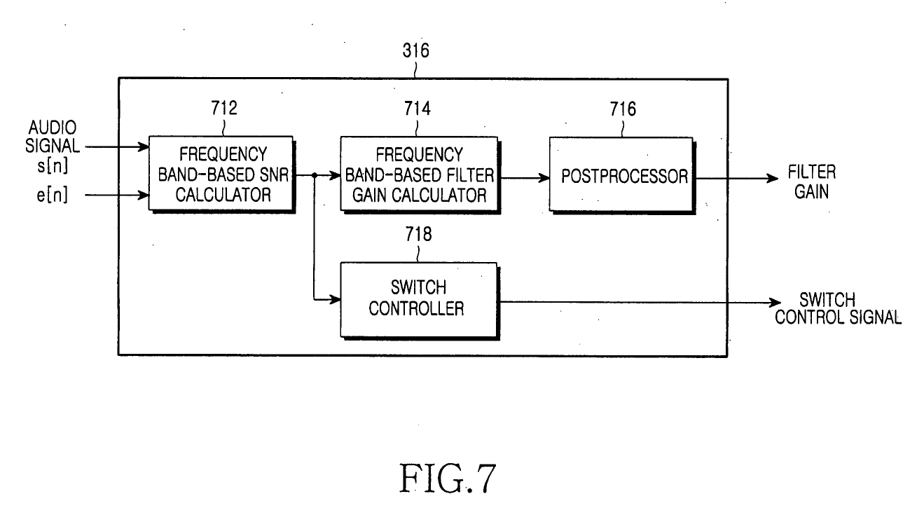

FIG. 7 shows the detailed construction of the filter gain/switch controller 316, which includes a frequency band-based SNR calculator 712, a frequency band-based filter gain calculator 714, a postprocessor 716, and a switch controller 718.

The frequency band-based SNR calculator 712 FFT-converts the input audio signal s[n] and the error signal \tilde{e}[n] calculated by the comparator 314 , respectively, and calculates a SNR in respective frequency bands shown in FIG. 5 or 6, as defined by equation (1) below.

$${SNR}_{n} [ i ] = \frac{{E}^{S} [ i ]}{{E}_{n}^{e} [ i ]} ; i = 1 , … , {N}_{B} \qquad ( 1 )$$

Wherein, i refers to each band; N_{B} refers to the total number of bands; n refers to the number of repeated feedback; E^{s} [i] refers to the energy of an input audio signal s[n] of an i^{th} band; and E^{e}ₙ [i] refers to the energy of an error signal \tilde{e}[n] calculated by the comparator 314 at n^{th} feedback of the i^{th} band.

The frequency band-based filter gain calculator 714 calculates the filter gain for each band with reference to SNR values for respective frequency bands, which have been calculated by the frequency band-based SNR calculator 712, as defined by equation (2) below.
Gₙ [i] =αf(SNRₙ [i])+(1−α)Gₙ₋₁ [i]; i=1, . . . , N_{B} (2 )

Wherein, Gₙ refers to a filter gain at n^{th} feedback; Gₙ₋₁ refers to a filter gain at (n−1)^{th} feedback; α refers to a regression coefficient, which is preferably 0.55 based on experiments; and f refers to a Sigmoid function having a value between [0,1 ], as defined by equation (3) below.

$$f ( x ) = \frac{1}{1 + {ⅇ}^{- x}} \qquad ( 3 )$$

When the filter gain is calculated for respective bands by the frequency band-based filter gain calculator 714 in this manner, the result is as follows: if the input audio signal s[n] of a frequency band is larger than the error signal \tilde{e}[n] calculated by the comparator 314, that frequency band has a large value, that is, about 1. If not, the frequency band has a small value, that is, about 0. Consequently, if bands can be encoded well by the encoder, they are increased, and if not, decreased. This process is repeated in a feedback loop so that the filter gain value converges to a value optimized for the current input audio signal s[n].

The postprocessor 716 aims at reducing the aliasing effect resulting from inter-frame deviation of filter gain between current and previous frames, as well as from intra-frame deviation of filter gain between bands in the current frame. In order to solve the problem of inter-frame deviation, the filter gain of the current frame, which is being searched, may be limited within a predetermined range based on an optimal filter gain determined for all of the frames. For example, the inter-frame deviation is limited within 0.3 for all of the frames, as defined by equation (4) below.

$$if ( \frac{\vert {G}_{n} [ i ] - {G}_{prev}^{*} [ i ] \vert}{{G}_{prev}^{*} [ i ]} < 0.3 ) \\ {G}_{n} [ i ] = {G}_{n} [ i ] \\ else if ( {G}_{n} [ i ] > {G}_{prev}^{*} [ i ] ) ; i = 1 , … , {N}_{B} \\ {G}_{n} [ i ] = {G}_{prev}^{*} [ i ] + 0.3 {G}_{prev}^{*} [ i ] \\ else \\ {G}_{n} [ i ] = {G}_{prev}^{*} [ i ] - 0.3 {G}_{prev}^{*} [ i ] \qquad ( 4 )$$

Wherein, G*ₚᵣₑᵥ [i] refers to an optimal filter gain of a previous frame determined for an i^{th} band.

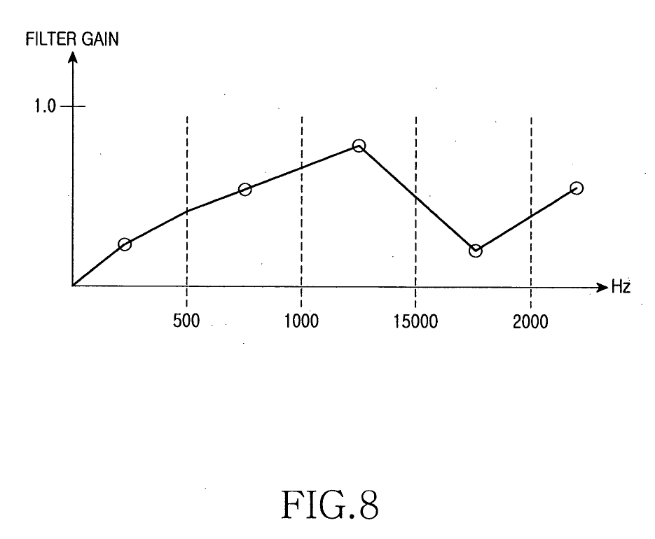

In order to solve the problem of intra-filter deviation, a linear or sinusoidal smoothing function may be used. FIG. 8 shows an exemplary use of a linear smoothing function. After the filter gain is determined for each band, the resulting value is set as the filter gain value at the central frequency of each band. The filter gain of remaining frequency components is determined by linearly connecting the filter gain values at respective central frequencies and obtaining resulting function values.

The switch controller 718 determines whether to continue the feedback process. When the feedback is repeated a predetermined number of times or when a convergence condition is satisfied, the switch controller 718 switches the system from a search mode to a transmission mode. The maximum number of feedback repetition is preferably 10, based on experiments. The convergence condition is that the rate of change of energy of the error signal \tilde{e}[n] be within 0.1, as defined by equation (5) below.

$$if ( \frac{\vert {\sum }_{i} ( {E}_{n}^{e} [ i ] - {E}_{n - 1}^{e} [ i ] \vert}{{\sum }_{i} {E}_{n - 1}^{e} [ i ]} ) < 0.1 \qquad ( 5 )$$

transmission mode,

else

search mode.

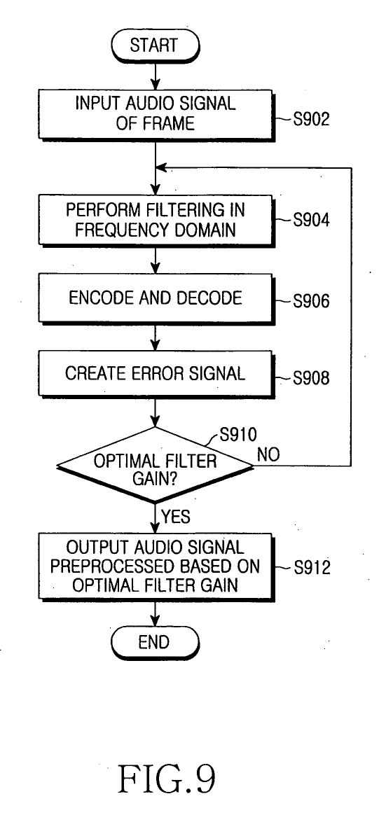

As mentioned above, the preprocessor 320 receives audio signals for each frame and preprocesses the audio signals. FIG. 9 is a flowchart showing steps for preprocessing audio signals for a frame by the preprocessor 320.

When an audio signal s[n] of a frame is inputted to the preprocessor 320 (S902), the preprocessing filter 310 filters the audio signal s[n] at the frequency filter 414 by using a filter gain and a filter gain value provided by the switch controller 316, so that a preprocessed audio signal \tilde{s}[n] is outputted (S904).

The preprocessed audio signal \tilde{s}[n] is encoded by the voice encoder/synthesizer 312. Then, the signal is decoded again and outputted as \tilde{s}[n] (S906).

The outputted \tilde{s}[n] is inputted to the comparator 314, which calculates the error between the audio signal s[n], which has been inputted in step S902, and outputs an error signal \tilde{e}[n] (S908).

Based on the error signal \tilde{e}[n] and the inputted audio signal s[n], the filter gain/switch controller 316 calculates an optimal preprocessing filter gain for the current input frame. When an optimal filter gain is obtained after feedback is repeated a predetermined number of times or when the convergence condition is satisfied (S910), the filter gain/switch controller 316 provides the preprocessing filter 310 with the optimal filter gain value.

The preprocessing filter 310 outputs an audio signal \tilde{s}[n], which has been preprocessed based on the optimal filter gain (S912).

If the filter gain/switch controller 316 fails to obtain an optimal filter gain, it returns to step S904 and repeats the ensuing steps until feedback is repeated a predetermined number of times or the convergence condition is satisfied.

In summary, the preprocessor 320 preprocesses inputted audio signals for each frame through the steps shown in FIG. 9. The resulting audio signals, which have been preprocessed optimally, are outputted to the voice encoder 332 of the signal transmitter 330. The voice encoder 332 voice-encodes the audio signals and transmits the audio signal. As such, the audio signals are preprocessed based on the characteristics of human auditory recognition before being transmitted. Therefore, the sound quality of the audio signals is hardly degraded by the voice encoder 332.

For example, the exemplary embodiments of present invention are applicable to ringback tones used in mobile telephone networks. Various types of music are commonly used as the ringback tones. When a ringback tone is transmitted to a user in a conventional manner, the voice encoder degrades the sound quality. If the ringback tone is preprocessed according to the present invention before being transmitted, the sound quality is hardly degraded. The ringback tone may be preprocessed in advance and stored separately, so that it can be transmitted via the voice encoder at the user's request. Alternatively, the ringback tone may be preprocessed every time the user requests the ringback tone and then transmitted.

As mentioned above, the exemplary embodiments of the present invention are advantageous in that, when audio signals are transmitted in a mobile telephone network, the sound quality of the audio signals is hardly degraded by the voice encoder, because the audio signals are preprocessed by using an optimal filter gain based on error signals obtained when the audio signals are preprocessed and outputted by the voice encoder and the synthesizer.

The exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, function programs, codes, and code segments for accomplishing the present invention can be easily construed as within the scope of the invention by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for transmitting audio signals, the apparatus comprising:
a preprocessing filter for converting an audio signal into a frequency domain and multiplying each frequency component by a filter gain value, the audio signal being inputted according to a frame, the preprocessing filter converting the audio signal in the frequency domain into a time domain and outputting the audio signal;
a first voice encoder/synthesizer for voice-encoding the audio signal outputted by the preprocessing filter, decoding the audio signal, and synthesizing the audio signal;
a comparator for outputting an error signal based on an error between the audio signal outputted by the first voice encoder/synthesizer and the audio signal inputted to the preprocessing filter;
a second voice encoder for voice-encoding the audio signal outputted by the preprocessing filter and transmitting the audio signal; and
a filter gain/switch controller for calculating a filter gain from the error signal outputted by the comparator and the audio signal inputted to the preprocessing filter, the filter gain being provided to the preprocessing filter, the filter gain/switch controller controlling the preprocessing filter when the filter gain is an optimal filter gain, so that the audio signal is processed according to the optimal filter gain and outputted to the second voice encoder.

2. The apparatus as claimed in claim 1, wherein the preprocessing filter comprises:
a frequency converter for converting the audio signal into the frequency domain, the audio signal is inputted to the preprocessing filter;
a frequency filter for multiplying the audio signal by the filter gain value, the audio signal is converted into the frequency domain by the frequency converter, and outputting the audio signal; and
an inverse frequency converter for converting the audio signal into the time domain, the audio signal is outputted by the frequency filter.

3. The apparatus as claimed in claim 1, wherein the filter gain/switch controller comprises:
a frequency band-based Signal-to-Noise Ratio (SNR) calculator for converting the error signal outputted by the comparator and the audio signal inputted to the preprocessing filter into the frequency domain, respectively, and calculating an SNR for each frequency band;
a frequency band-based filter gain calculator for calculating the filter gain for each frequency band by using the SNR calculated by the frequency band-based SNR calculator;
a postprocessor for adjusting deviation of the filter gain and providing the filter gain to the preprocessing filter; and
a switch controller for controlling the preprocessing filter when the filter gain is an optimal filter gain, so that the audio signal is processed according to the optimal filter gain and outputted to the second voice encoder.

4. The apparatus as claimed in claim 3, wherein the postprocessor limits the filter gain within a range based on a filter gain optimized for an audio signal inputted in a previous frame.

5. The apparatus as claimed in claim 3, wherein the postprocessor determines a filter gain at a central frequency of each frequency band as a filter gain for each frequency band and obtain a filter gain of remaining frequency components by connecting filter gains at respective central frequencies along a straight line.

6. The apparatus as claimed in claim 3, wherein the postprocessor determines a filter gain at a central frequency of each frequency band as a filter gain for each frequency band and obtain a filter gain of remaining frequency components by connecting filter gains at respective central frequencies along a curved line.

7. The apparatus as claimed in claim 3, wherein the switch controller determines that the filter gain is an optimal filter gain when a rate of change of energy of the error signal is at least one of equal to and smaller than a reference value and control the preprocessing filter to process the audio signal according to the optimal filter gain and output the audio signal to the second voice encoder.

8. The apparatus as claimed in claim 3, wherein the switch controller determines that the filter gain is an optimal filter gain when calculation of the filter gain by the preprocessing filter, the first voice encoder/synthesizer, and the comparator are repeated a number of times and control the preprocessing filter to process the audio signal according to the optimal filter gain and output the audio signal to the second voice encoder.

9. The apparatus as claimed in claim 1, wherein the first voice encoder/synthesizer comprises a linear prediction analyzer and a synthesizer.

10. The apparatus as claimed in claim 1, wherein the first voice encoder/synthesizer comprises a pitch analyzer and a synthesizer.

11. The apparatus as claimed in claim 1, wherein the first voice encoder/synthesizer comprises a fixed-codebook analyzer and a synthesizer.

12. A method for transmitting audio signals after inputted audio signals are preprocessed according to frames and encoded, the method comprising:
converting an audio signal inputted based on a frame into a frequency domain, multiplying each frequency component by a filter gain value, converting the audio signal in the frequency domain into a time domain, and outputting the audio signal;
voice-encoding the audio signal outputted, decoding the audio signal, the audio signal is voice-encoded, and synthesizing the audio signal;
calculating an error between the audio signal synthesized and the audio signal inputted and outputting an error signal;
calculating and providing a filter gain by using the error signal and the audio signal inputted; and
voice-encoding and transmitting the audio signal when the filter gain is an optimal filter gain, the audio signal is preprocessed according to the optimal filter gain and outputted.

13. The method as claimed in claim 12, wherein the calculating and providing of a filter gain comprises:
converting the error signal and the audio signal inputted into the frequency domain, respectively, and calculating a Signal-to-Noise Ratio (SNR) for each frequency band;
calculating the filter gain for each frequency band by using the SNR; and
adjusting deviation of the filter gain and providing the filter gain for preprocessing.

14. The method as claimed in claim 13, wherein the deviation of the filter gain is adjusted by limiting the filter gain within a range based on a filter gain optimized for an audio signal inputted in a previous frame.

15. The method as claimed in claim 13, wherein the deviation of the filter gain is adjusted by determining a filter gain at a central frequency of each frequency band as a filter gain for each frequency band and connecting filter gains at respective central frequencies along a straight line to obtain a filter gain of remaining frequency components.

16. The method as claimed in claim 13, wherein the deviation of the filter gain is adjusted by determining a filter gain at a central frequency of each frequency band as a filter gain for each frequency band and connecting filter gains at respective central frequencies along a curved line to obtain a filter gain of remaining frequency components.

17. The method as claimed in claim 12, wherein the filter gain is determined as an optimal filter gain when a rate of change of energy of the error signal is at least one of equal to and smaller than a reference value.

18. The method as claimed in claim 12, wherein the filter gain is determined as an optimal filter gain when calculation of the filter gain by the converting of the audio signal, the voice-encoding of the audio signal, and the calculating of the error is repeated a number of times.

19. The apparatus as claimed in claim 2, wherein the filter gain/switch controller comprises:
a frequency band-based Signal-to-Noise Ratio (SNR) calculator for converting the error signal outputted by the comparator and the audio signal inputted to the preprocessing filter into the frequency domain, respectively, and calculating an SNR for each frequency band;
a frequency band-based filter gain calculator for calculating the filter gain for each frequency band by using the SNR calculated by the frequency band-based SNR calculator;
a postprocessor for adjusting deviation of the filter gain and providing the filter gain to the preprocessing filter; and
a switch controller for controlling the preprocessing filter when the filter gain is an optimal filter gain, so that the audio signal is processed according to the optimal filter gain and outputted to the second voice encoder.

20. A computer-readable recording medium storing a computer program code for performing a method for transmitting audio signals after inputted audio signals are preprocessed according to frames and encoded, the method comprising:
converting an audio signal inputted based on a frame into a frequency domain, multiplying each frequency component by a filter gain value, converting the audio signal in the frequency domain into a time domain, and outputting the audio signal;
voice-encoding the audio signal outputted, decoding the audio signal, the audio signal is voice-encoded, and synthesizing the audio signal;
calculating an error between the audio signal synthesized and the audio signal inputted and outputting an error signal;
calculating and providing a filter gain by using the error signal and the audio signal inputted; and
voice-encoding and transmitting the audio signal when the filter gain is an optimal filter gain, the audio signal is preprocessed according to the optimal filter gain and outputted.
